(19) United States
(12) Patent Application Publication
(10) Pub. No.: US 2009/0281810 A1
(43) Pub. Date: Nov. 12, 2009

(54) SYSTEM AND METHOD FOR VISUALLY PRESENTING AUDIO SIGNALS

(75) Inventors: Istvan Sziklai, Budapest (HU); Istvan Hazman, Budapest (HU); Jozsef Imrek, Debrecen (HU)

Correspondence Address: YOUNG & THOMPSON, 209 Madison Street, Suite 500, ALEXANDRIA, VA, 22314, US

(73) Assignee: Ave-Fon Kft., Debrecen (HU)

(21) Appl. No.: 12/306,571

(22) PCT Filed: Jun. 25, 2007
(86) PCT No.: PCT/HU2007/000057

§ 371 Date: Mar. 24, 2009

(30) Foreign Application Priority Data
Jun. 27, 2006 (HU) P0600540

(51) Int. Cl. G10L 21/06

(52) U.S. Cl. 704/276; 704/E21.019

(57) ABSTRACT

A method of visually presenting audio signals includes receiving an audio signal to be presented; generating a predetermined number of discrete frequency components from the audio signal; assigning a graphical object to each of the frequency components, each of the graphical objects being specified by a geometrical shape, a position information and a size information; and all of the graphical objects associated with all of the frequency components are displayed simultaneously on a graphic display. The system includes a microphone for generating audio signals; an audio interface unit for sampling the audio signals and transforming them into digital signals; a processing unit for translating digital signals into a predetermined number of discrete frequency components and for assigning a graphical object to each of the discrete frequency components; a video interface unit for generating a video signal; and a graphic display for displaying a sonogram based on the video signal.

The present invention relates to a system and a method for visually presenting audio signals, wherein image signals generated from audio signals are displayed in graphical form.

To habilitate hearing and to develop the speech production skills of patients suffering from serious hearing loss or even from total deafness, mainly surgical solutions have been applied so far. Such a surgical method for habilitation of hearing is the so called cochlear implantation, wherein the hearing capability is improved by means of electrodes implanted into the cranium. For infants, such surgical actions, however, cannot be practically carried out because of the undeveloped state of their bony system. At the same time, adaptiveness of the brain is very strong at the early age, particularly at the age of one month or a few months. The sooner the habilitation of hearing starts, the more perfect hearing or speech production skills may be reached. Nowadays, various experiments focus on the habilitation of hearing without surgical action, the most promising method of them being the visual presentation of the speech sounds for hearing impaired persons. Applicability of the so called audio-visual transcoding devices is based on the principle that the extreme plasticity of the brain—particularly at the early age—makes it possible to partly or even completely replace the function of hearing with the function of sight.

U.S. Pat. No. 6,351,732 discloses an audio-visual transcoding device, in which the audio signals produced from speech sounds recorded by a microphone are separated into a plurality of discrete frequency components, and each of the frequency components are translated into control signals for controlling an array of light sources, such as light emitting diodes. The display containing the light sources is arranged on the head of a patient so as practically not to disturb his vision. The drawback of this device is that separate control signals are used to control each light source or each array of light sources, therefore due to the hardware based implementation, the displaying format of the visual information generated from an audio signal cannot be configured.

One object of the present invention is to provide an audio-visual transcoding system and method, wherein the displaying format of the visual information is not limited by the fixed hardware arrangement, that is the displaying format of the sound image (sonogram) generated from an audio signal may be configured within wide ranges by means of various parameters.

Another object of the present invention is to provide a system and a method for audio-visual transcoding that allow to take advantage of the complex information collecting capability of the function of sight in a much more efficient and intensive manner than ever before.

These and other objects are achieved by providing a method of visually presenting audio signals, said method comprising the steps of receiving an audio signal to be presented; generating a predetermined number of discrete frequency components from said audio signal; assigning a graphical object to each of the frequency components, said graphical object being specified by a geometrical shape, a position information and a size information; and all of said graphical objects associated with all of said frequency components are displayed simultaneously on a graphic display.

It is preferred that a colour information is assigned to the graphical object of each frequency component.

The size of a graphical object is preferably determined as a function of the intensity of the associated frequency component, whereas the position and the colour of a graphical object are preferably determined as a function of the frequency of the associated frequency component.

In an embodiment of the method according to the present invention, the graphical objects are presented in the form of plane figures, and when two graphical objects overlap each other, the graphical object of the frequency component with the lower frequency is masked by the graphical object of the frequency component with the higher frequency.

Preferably, the separation of an audio signal into discrete frequency components, as well as displaying of the graphical objects are performed in real time.

In a preferred embodiment of the method according to the present invention, the geometrical shape of the graphical objects is a square, and the size information gives the area of the square.

The colour information of each graphical object may be specified by a colour selected from the spectrum of the visible light so that the colour of the graphical object of any frequency component be perceivably different from the colour of the graphical object of any other frequency component.

The above objects are further achieved by providing a system for visually presenting audio signals, said system comprising a microphone for generating audio signals; an audio interface unit for sampling the audio signals and transforming it into digital signals; a processing unit for separating the digital signal into a predetermined number of discrete frequency components and for assigning a graphical object to each discrete frequency component; a video interface unit for generating a video signal based on said graphical objects; and a graphic display for displaying a sonogram based on the video signal, said sonogram consisting of said graphical objects.

Due to displaying the visual information, generated from an audio signal, on a graphic display in a graphical form, any kind of abstract visual information may be presented, and the system may be configured according to personal requirements without the need of modifying the hardware arrangement of the system. A further advantage of the present invention is that in addition to the position information and the size information, the graphical presentation of the sonogram is also adapted to provide shape information and colour information, thus it makes use of the very complex function of sight in a much more intensive way.

The present invention will be now described in more detail with reference to the accompanying drawings, wherein:

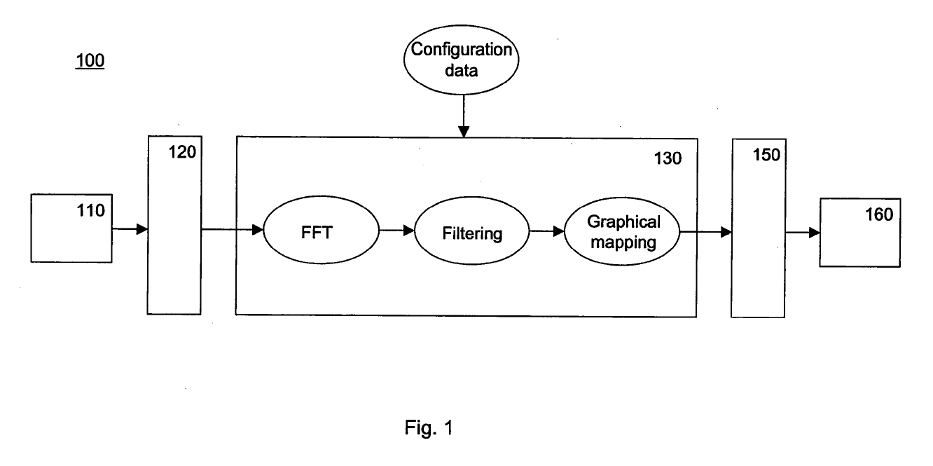

FIG. 1 is a schematic block diagram of the audio-visual transcoding system according to the present invention, and

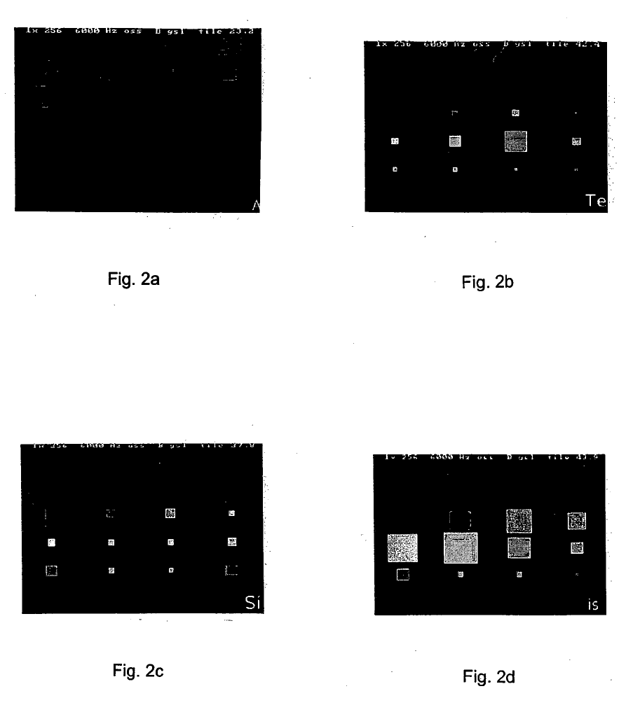

FIGS. 2a-d illustrate sonograms for various input audio signals as displayed by the system according to the present invention.

FIG. 1 illustrates a schematic block diagram of the audio-visual transcoding system 100 according to the invention. In the system 100, a microphone 110 is used as a primary sound source. The electrical signals produced by the microphone 110 are received by an audio interface unit 120 that produces digital signals from the incoming analogue electrical signals for a processing unit 130. The maximum bandwidth of the signal to be processed is determined by the sampling frequency applied by the audio interface unit 120. According to Nyquist's sampling theorem, the bandwidth is defined as the half of the sampling frequency. With respect to the fact that the bandwidth of interest regarding the speech is the frequency range of 125 Hz to 3000 Hz, the sampling frequency used in the system according to the invention is preferably at least 6000 Hz. It should be noted that the sampling frequency is not limited to this value, but it may be even significantly different therefrom depending on the particular application.

The system 100 according to the invention may comprise a secondary sound source (not shown in the drawings) for the purpose of calibration. The secondary sound generator is preferably a built-in sine generator. The secondary sound source may be used to check the operation of the signal processing unit 130 or to study the signal processing itself.

Preferably, the sampling frequency applied by the audio interface unit 120 can be modified within a certain range in order to allow a flexible use of the system. In case the audio interface unit 120 is in the form of a sound card, the applicable sampling frequency is primarily defined by the hardware configuration or the driver of the sound card.

The digital signal produced by the audio interface unit 120 is subject to fast Fourier transformation (FFT) by the processing unit 130 so as to obtain the frequency spectrum of the digitized audio signal. The spectrum resulted from the fast Fourier transformation is divided into a predetermined number of frequency ranges, and a frequency component having a specific intensity (amplitude) according, for example, to the signal power of the particular range, is assigned to each of the frequency ranges. In a preferred embodiment of the system 100 according to the invention, the frequency range having importance with respect to the speech, i.e. the range between 125 Hz and 3000 Hz, is divided, for example, into 30 bands, thus 30 discrete frequency components are assigned to the incoming audio signal. Hence, five frequency components may be visually presented for every octave.

In the system 100 according to the present invention, the fast Fourier transformation may be performed in four different ways as described hereinafter.

The application “integer FFT” is used for processing only samples with a predetermined number (24, 64 or 80) input points, and the it performs integer based computations.

The application “gsl FFT” uses the mixed radix real FFT algorithm that can be accessed in the GNU Scientific Library. This application is adapted to process samples of an arbitrary number of input points, and it automatically factorizes the FFT into FFTs with radices 2, 3, 4, 5, 6, and if possible, with radix 7.

The application “fftw FFT” uses half complex FFT transformation that can be accessed in the FFTW C Library. This application carries out a detailed test with respect to the possible factorizations in order to find the fastest algorithm, therefore this application has a longer initialization period. This feature should be taken into account when the sampling frequency or the number of frequency components is to be changed.

The application “reference FFT” is a standard application based on a discrete Fourier transformation. Because of not performing optimization, this application is the slowest one of said four applications. Consequently, the application “reference FFT” can be used only for checking the results of the above three applications.

The spectrum generated by the fast Fourier transformation is subject to smoothing by means of an input filter. Although the input filter reduces the frequency resolution of the system, at the same time it significantly reduces the information loss (frequency leakage) during the FFT, too. In the system according to the invention, three types of input filter may be used, namely a square window, a Hamming window or a Blackman window.

It is an essential feature of the filter of the type “square window” that it does not modify the amplitude of the original signal. This type of filter provides the highest filter resolution, but at the same time, it produces a significant distortion of the signal.

The filter of the type “Hamming window” multiplies the number of the input points according to a special formula, thus influencing both the refresh rate of the image and the amplitude of the signal to be processed. Relatively to the filter of the type “square window”, this filter results in a much lower frequency resolution in the one hand, but it is much less sensitive to the non-primary frequencies, and therefore it produces an insignificant signal distortion, on the other hand.

The filter of the type “Blackman window” also multiplies the number of the input points according to a special formula, thus influencing both the refresh rate of the image and the amplitude of the signal to be processed, too. This type of filter provides the lowest frequency resolution, while it produces practically no signal distortion.

When the audio signal contains too much noise or the amplitudes of the different frequency components are changing too quickly, the filtering may be carried out by executing a method of moving averaging in order to obtain the useful signal content of the frequency spectrum generated by the fast Fourier transformation. During the moving averaging, a predetermined number N of points is replaced with their mean value. It is obvious that if N=1, the moving averaging will not filter the input signal. The width of the window, i.e. the value of N, used for the moving averaging should be set to an optimal value with respect to the interaction between the fastest possible displaying and the highest possible signal to noise ratio.

In the system according to the invention, it is also possible to use a so called rebinning filter that produces output points, the number of which is different from the number of the points generated by the FFT algorithms. The output points are generated by re-distributing the energy of the input points processed. The rebinning filtering, if needed, is performed by the processing unit 130.

A fundamental feature of the system according to the invention that the audio signals are transformed into abstract images providing information, inter alia, on the sound pitch, the sound intensity, the sound tone colour, etc. of the speaking person. In the system according to the invention, the abstract image is composed of graphical objects presented on a graphic display. Preferably, one graphical object is associated with each frequency component, but alternatively, even a plurality of different graphical objects may be associated with a particular frequency component in a given implementation. In the system 100 according to the invention, mapping of the frequency components into graphical objects is carried out by the processing unit 130.

To each graphical object, a geometrical shape, a position information and a size information are assigned. In a particularly preferred embodiment of the present invention, a colour information is additionally assigned to the graphical objects. The geometrical shape may be a point, a line or a plane figure, such as a square, a circle or any other regular or irregular plane figure. The size information relates to the dimensions (if interpretable) of the graphical object, i.e. in case of a line, to the length of the line, or in case of a plane figure, to the area thereof. The position information defines the position of a preferential point of the graphical object on the graphic display. In case of a line, said preferential point may be, for example, any end point of the line, whereas in case of a plane figure, the preferential point may be, for example, the central point or any other reference point of the plane figure. The graphical objects are presented in the form of points when the wave form of the audio signal is to be displayed before and after the input filtering. When the frequency components are represented in the form of horizontal or vertical lines (column diagram), the length of a line (or a column) indicates the intensity of the respective frequency component. The performance of the system according to the invention can be utilized to the greatest extent when the graphical objects are displayed in the form of plane figures, preferably in the form of regular plane figures like squares.

The graphical objects associated with the respective frequency components are arranged in the sonogram successively, preferably in lines and/or columns. When the graphical object are presented in the form of plane figures, they are preferably arranged in such a way that the graphical object of the frequency component with the lowest frequency is located at the upper left corner of the sonogram, whereas the graphical object of the frequency component with the highest frequency is located at the lower right corner of the image. When the graphical objects are represented in the form of plane figures, the area of a plane figure is defined by the intensity (amplitude) of the respective frequency component. Returning to the above mentioned example, if 30 frequency components are associated with the audio signal, the plane figures of the frequency components are arranged in a matrix consisting of five lines and six columns. The area of every plane figure depends on the intensity of the respective frequency component, whereas their colour depends on the frequency of the respective frequency component. The graphical sonogram thus obtained provides enough difference between the images of the speech sounds or the words so as to allow to recognise the difference between similar sounds or words. According to practical experiences, a sonogram displaying 30 frequency components presents an image without too much details, while the image changes following the rhythm of the speech do not disturb the comprehension of the words or the matter.

If the graphical objects situated in adjacent positions are allowed to overlap, the overlapping graphical objects are preferably displayed in such a way that the graphical object of a frequency component with a higher frequency masks the graphical object of a frequency component with a lower frequency. By assigning colour information to the frequency components, it is also feasible to encode the graphical objects belonging to different frequency components with different colours.

Based on the sonogram presenting the graphical objects assigned to the frequency components, a video signal is generated by means of a video interface unit 150 and is transmitted to a graphic display 160 for displaying the sonogram in graphical form. Preferably, the graphic display 160 is a small display fixable to the head of the patient, for example a pair of video glasses, said display having dimensions that allow for the patient to receive a substantial amount of visual information while not interfering to a significant extent to the normal vision of the patient. In an alternative embodiment of the system 100 according to the present invention, the video signal is transmitted through wireless interconnection, e.g. Bluetooth, between the video interface unit 150 and the graphic display 160, which has importance primarily in the case of infants.

The parameters used for displaying the graphical sonogram (filtering, signal processing, graphical object describing, etc. parameters) are stored in a configuration file. Theses configuration parameters specifying the operation of the system and the graphical presentation may be adjusted even during the operation of the system.

In a preferred embodiment of the system according to the invention, the audio signals, i.e. the speech sounds, are transformed into digital signals in real time, and if the image resolution, the refresh rate, etc. of the graphic display allows it, the sonogram consisting of the graphical objects of the frequency components are also displayed in real time. Thereby a continuous visual presentation of the live speech may be achieved, thus not only the separate (static) sound images, but also the time dependent changes of the sound images carry visual information.

The graphic display 160 is preferably in the form of a monitor of a pair of video glasses, wherein it is preferred that the display covers the upper outer quarter of one eye's field of vision, thus not reducing the field of vision of the patient to a disturbing extent.

It is obvious for a person skilled in the art that the system according to the invention may be simply carried out by using a general purpose computing device programmed specifically, i.e. operated by an application specific software. In such a case, the audio interface unit 130 for receiving and sampling the audio signals and for transforming those into digital signals, is typically a sound card, the processing unit 130 is typically a microprocessor of the computing device, and the video interface unit 150 is typically a video card. In the system according to the invention, the number of the frequency components, the display format of the graphical objects, in particular the geometrical shape, the colour and the arrangement of the graphical objects, may be changed freely within a wide range. The system may be configured by loading a configuration data file having a predetermined format, in the simplest case, or through a graphical user interface, in a more complicated case, for example in the case of using a personal computer.

FIGS. 2.a-d illustrates the sonograms of various sounds and syllables. FIG. 2.a shows the sonogram of a recorded sound “a” pronounced by a man. As it can be recognised in FIG. 2.a, a man's sound “a” is primarily composed of frequency components of lower frequencies. FIG. 2.b shows the sonogram of a recorded syllable “te” pronounced by a man, and FIG. 2.c shows the sonogram of a recorded syllable “si” pronounced also by a man. One can see clearly in both of FIG. 2.b and FIG. 2.c that in case of graphical objects situating in adjacent positions and overlapping each other (that are squares in the figures shown), the objects of the frequency components of higher frequencies are overlying on the objects of the frequency components of lower frequencies. In FIG. 2.d, the sonogram of a recorded syllable “is” pronounced by a woman is shown. It appears from FIG. 2.d that in a female voice, the frequency components with higher frequencies are much more intensive, thus the system according to the invention also allows to distinguish a male voice from a female voice.

The sonograms of FIGS. 2.a-d have been recorded by applying a sampling frequency of 6000 Hz, an input filter of the type “Blackman window” and the “gsl FFT” algorithm. In the sonograms, the frequency components of the lowest frequencies are displayed with colours of large wavelength (red), whereas the frequency components of the highest frequencies are displayed with colours of small wavelength (violet). The middle frequencies are displayed in colours of the colour transition between the red and the violet, i.e. in yellow, green, blue, etc.

The system of the present invention has the great advantage that the visual presentation of the audio signals may be configured freely within a certain range, thereby the habilitation treatment of hearing or replacement of the function of hearing with the function of sight may be customized for the person and may be changed at any time during the treatment so that the most efficient mode of presentation be always set with respect to the treatment. A further advantage of the invention is that the abstract image or series of images presented in the graphic display provides complex visual information that allows to conduct a therapy in a much more efficient and intensive way than ever before.

1-10. (canceled)

11. A method for visually presenting audio signals, said method comprising the steps of:
a) receiving an audio signal to be presented; and
b) generating a predetermined number of discrete frequency components from said audio signal, each of said frequency components having a predetermined frequency;
wherein the method further comprises the steps of:
c) assigning a plane figure to each of the frequency components, each of said plane figures being specified by a geometrical shape, a position information and a size information; and
d) all of said plane figures associated with all of said frequency components are displayed simultaneously on a graphic display, each of said plane figures being presented in the form according to its geometrical shape, in the position according to its position information and in the size according to its size information.

12. The method of claim 11, wherein a colour information is further assigned to the plane figure of each of said frequency components, and each of said plane figures is presented in the colour according to its colour information.

13. The method of claim 11, wherein the size of a plane figure is determined as a function of the intensity of the associated frequency component.

14. The method of claim 11, wherein the position and the colour of a plane figure are determined as a function of the frequency of the associated frequency component.

15. The method of claim 11, wherein overlapping of at least the adjacent plane figures are allowed and when two plane figures overlap each other, the plane figure of the frequency component with the lower frequency is masked by the plane figure of the frequency component with the higher frequency.

16. The method of claim 11, wherein said audio signal is separated into a plurality of said discrete frequency components in real time.

17. The method of claim 11, wherein said plane figures are displayed in real time.

18. The method of claim 11, wherein the geometrical shape of each of said plane figures is a square, and the size information specifies the area of the square.

19. A system for visually presenting audio signals, the system comprising
a) a microphone for generating audio signals and
b) an audio interface unit for sampling an audio signal and for transforming it into a digital signal,
wherein the system further comprises
c) a processing unit for separating the digital signal into a predetermined number of discrete frequency components with predetermined frequencies and for assigning a plane figure to each of said discrete frequency components with specifying a geometrical shape, a position information and a size information for each of said plane figures;
d) a video interface unit for generating a video signal based on said plane figures; and
e) a graphic display for displaying a sonogram based on the video signal, said sonogram consisting of said plane figures.
